(19) United States
(12) Patent Application Publication
(10) Pub. No.: US 2024/0033999 A1
(43) Pub. Date: Feb. 1, 2024

(54) Plasticizing Device, Three-Dimensional Shaping Device, And Injection Molding Device

(71) Applicant: SEIKO EPSON CORPORATION, Tokyo (JP)

(72) Inventors: Yuta SAKAI, Shiojiri (JP); Kazuhide NAKAMURA, Asahi (JP); Masayuki GOZU, Ina (JP); Masaaki OGIHARA, Matsumoto (JP)

(21) Appl. No.: 18/360,174

(22) Filed: Jul. 27, 2023

(30) Foreign Application Priority Data
Jul. 28, 2022 (JP) 2022-120102

(51) Int. Cl. B29C 64/393; B29C 64/295; B29C 45/47; B29C 45/74; B29C 45/78; B33Y 30/00; B33Y 50/02

(52) U.S. Cl. CPC B29C 64/393; B29C 64/295; B29C 45/47; B29C 45/74; B29C 45/78; B33Y 30/00; B33Y 50/02; B29C 64/209

(57) ABSTRACT

A plasticizing device plasticizes a material to generate a plasticized material. The plasticizing device includes a screw having a groove forming surface on which a groove is formed, a barrel having a facing surface that faces the groove forming surface and formed with a communication hole through which the plasticized material flows outside, a first heating unit disposed in the barrel and configured to heat the material supplied to the groove, and a first detection unit that is disposed in the barrel and configured to detect a temperature of the groove. The barrel is formed with a first hole for accommodating the first heating unit and a second hole for accommodating the first detection unit. A direction in which the first hole extends coincides with a direction in which the second hole extends. The first heating unit and the first detection unit are coupled to each other via a fixing member.

The present application is based on, and claims priority from JP Application Serial Number 2022-120102, filed Jul. 28, 2022, the disclosure of which is hereby incorporated by reference herein in its entirety.

### BACKGROUND

### 1. Technical Field

The present disclosure relates to a plasticizing device, a three-dimensional shaping device, and an injection molding device.

### 2. Related Art

For example, JP-A-2020-179580 discloses a plasticizing device equipped with a flat screw, a three-dimensional shaping device, and an injection molding device

The plasticizing device, the three-dimensional shaping device, and the injection molding device require periodical maintenance, and maintenance work is complicated because structures of the devices are complicated.

### SUMMARY

According to a first aspect of the present disclosure, a plasticizing device is provided. The plasticizing device plasticizes a material to generate a plasticized material. The plasticizing device includes a screw having a groove forming surface on which a groove is formed, a barrel having a facing surface that faces the groove forming surface and formed with a communication hole through which the plasticized material flows outside, a first heating unit disposed in the barrel and configured to heat the material supplied to the groove, and a first detection unit disposed in the barrel and configured to detect a temperature of the groove. The barrel is formed with a first hole for accommodating the first heating unit and a second hole for accommodating the first detection unit. A direction in which the first hole extends coincides with a direction in which the second hole extends. The first heating unit and the first detection unit are coupled to each other via a fixing member.

According to a second aspect of the present disclosure, a three-dimensional shaping device is provided. The three-dimensional shaping device includes the plasticizing device and a nozzle configured to discharge the plasticized material toward a table.

According to a third aspect of the present disclosure, an injection molding device is provided. The injection molding device includes the plasticizing device and a nozzle configured to inject the plasticized material into a molding mold.

### BRIEF DESCRIPTION OF THE DRAWINGS

FIG. 1 is an explanatory view illustrating a schematic configuration of a three-dimensional shaping device.

FIG. 2 is an explanatory view illustrating a schematic configuration of the three-dimensional shaping device.

FIG. 3 is a perspective view illustrating a schematic configuration of a screw.

FIG. 4 is a schematic plan view illustrating a barrel.

FIG. 5 is a side view illustrating the barrel and a block.

FIG. 6 is a perspective view illustrating a heater unit.

FIG. 7 is a view illustrating a state in which the heater unit is coupled to a shaping unit.

FIG. 8 is a cross-sectional view taken along a plane perpendicular to a Y direction and illustrating a barrel and a block according to a second embodiment.

FIG. 9 is a cross-sectional view taken along a plane perpendicular to an X direction and illustrating the block according to the second embodiment.

FIG. 10 is a view illustrating an example of a method of removing a solid matter adhering to a communication hole of the barrel.

FIG. 11 is a view illustrating an example of a method of removing a solid matter adhering to a flow path of the block.

FIG. 12 is a perspective view illustrating a plunger unit.

FIG. 13 is a view illustrating a state in which the plunger unit is coupled to a plasticizing device.

FIG. 14 is a perspective view illustrating a placement portion.

FIG. 15 is a perspective view illustrating a three-dimensional shaping device according to a third embodiment.

FIG. 16 is a perspective view illustrating a plasticizing device in a state in which a first portion and a second portion are separated.

FIG. 17 is an explanatory view illustrating a schematic configuration of an injection molding device according to a fourth embodiment.

FIG. 18 is a cross-sectional view illustrating a schematic configuration of a plasticizing device and a mold clamping device according to the fourth embodiment.

### DESCRIPTION OF EMBODIMENTS

### A. First Embodiment

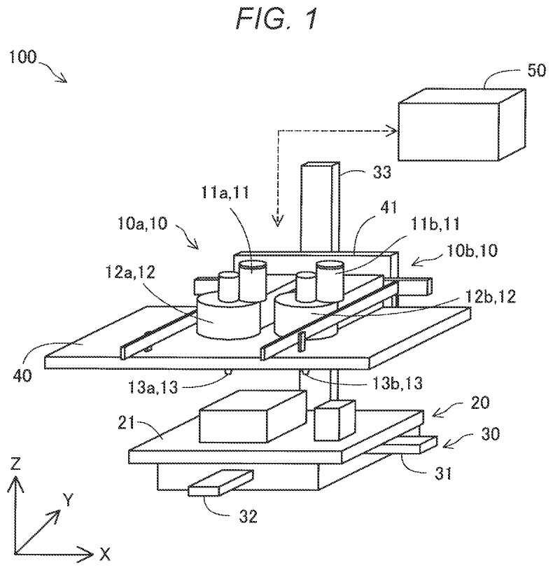

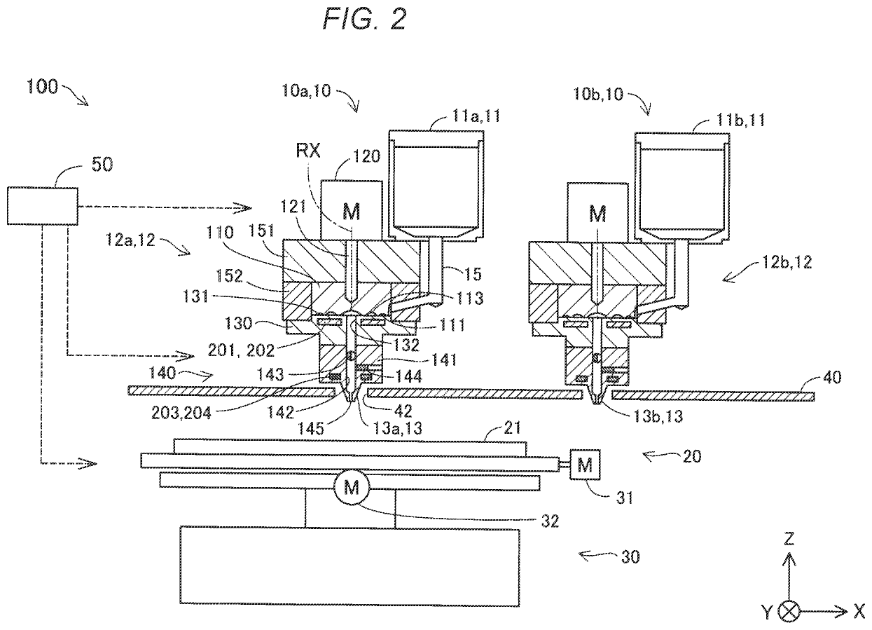

FIGS. 1 and 2 are explanatory views illustrating a schematic configuration of a three-dimensional shaping device 100 according to the embodiment. Arrows indicating X, Y, and Z directions orthogonal to one another are illustrated in FIGS. 1 and 2. The X direction and the Y direction are parallel to a horizontal plane. The Z direction is a direction parallel to a vertical direction. The X, Y, and Z directions in FIGS. 1 and 2 and X, Y, and Z directions in other drawings indicate the same directions. When a direction is specified, “+” indicates a positive direction that is a direction indicated by an arrow, “−” indicates a negative direction that is a direction opposite to the direction indicated by an arrow, and positive and negative symbols are used together to indicate directions.

The three-dimensional shaping device 100 includes a shaping unit 10, a table 20, a position changing unit 30, a table heating unit 40, and a control unit 50.

The control unit 50 is a control device that controls an overall operation of the three-dimensional shaping device. The control unit 50 is implemented by a computer including one or a plurality of processors, a memory, and an input and output interface that inputs a signal from and outputs a signal to the outside. The control unit 50 has various functions such as a function of executing shaping processing for shaping a three-dimensional shaped object by causing the processor to execute a program or a command read into a main storage device. Instead of being implemented by a computer, the control unit 50 may be implemented by a configuration in which a plurality of circuits for implementing at least a part of the functions are combined.

Under the control of the control unit 50, the shaping unit 10 discharges, onto the table 20 serving as a base of a three-dimensional shaped object, a plasticized material obtained by plasticizing a solid material into a paste-like material. The shaping unit 10 includes a material supply unit 11, a plasticizing device 12, and a nozzle 13. The shaping unit 10 is also referred to as a head.

The three-dimensional shaping device 100 includes a first shaping unit 10a and a second shaping unit 10b as the shaping unit 10. The first shaping unit 10a includes a first material supply unit 11a as the material supply unit 11, a first plasticizing device 12a as the plasticizing device 12, and a first nozzle 13a as the nozzle 13. The second shaping unit 10b includes a second material supply unit 11b as the material supply unit 11, a second plasticizing device 12b as the plasticizing device 12, and a second nozzle 13b as the nozzle 13. The first shaping unit 10a and the second shaping unit 10b are arranged side by side in the X direction such that positions thereof in the Y direction coincide with each other. The second shaping unit 10b is disposed at a position in the +X direction of the first shaping unit 10a. Since a configuration of the first shaping unit 10a and a configuration of the second shaping unit 10b are the same, when the first shaping unit 10a and the second shaping unit 10b are not particularly distinguished from each other, the two shaping units may be simply referred to as the shaping unit 10. When components of the two shaping units need to be distinguished from each other, a component of the first shaping unit 10a is denoted by a reference numeral “a”, and a component of the second shaping unit 10b is denoted by a reference numeral “b”.

The material supply unit 11 supplies a material to be used for generating a plasticized material to the plasticizing device 12. The material supply unit 11 is implemented by, for example, a hopper. The material supply unit 11 contains a pellet-shaped material or a powdery material. Examples of the material include thermoplastic resin such as polypropylene resin (PP), polyethylene resin (PE), and polyacetal resin (POM). A communication path 15 that couples the material supply unit 11 and the plasticizing device 12 is provided below the material supply unit 11. The material supply unit 11 supplies a material to the plasticizing device 12 via the communication path 15.

The plasticizing device 12 plasticizes at least a part of the material supplied from the material supply unit 11, generates a paste-like plasticized material having fluidity, and guides the material to the nozzle 13. Here, the term “plasticizing” is a concept including melting, and refers to changing from a solid state to a state having fluidity. Specifically, in case of a material in which glass transition occurs, the term plasticizing refers to setting a temperature of the material to be equal to or higher than a glass transition point. In case of a material in which glass transition does not occur, the term “plasticizing” refers to setting a temperature of the material to be equal to or higher than a melting point. The plasticizing device 12 includes a screw 110, a drive motor 120, a barrel 130, and a discharge unit 140.

As illustrated in FIG. 2, the screw 110 is accommodated in a lower case 152. An upper surface side of the screw 110 is coupled to the drive motor 120 via a drive shaft 121. The screw 110 is rotated integrally with the drive shaft 121 when the drive motor 120 applies a drive force to the drive shaft 121. A rotation axis RX of the screw 110 coincides with an axis of the drive shaft 121. An axial direction of the rotation axis RX of the screw 110 is a direction along the Z direction. A rotation speed of the screw 110 is controlled by controlling a rotation speed of the drive motor 120 by the control unit 50. The screw 110 may be driven by the drive motor 120 via a speed reducer. The screw 110 is also referred to as a rotor or a flat screw. The drive shaft 121 is provided in an upper case 151 located above the lower case 152.

The barrel 130 is provided at a −Z direction side of the screw 110. A facing surface 131 which is an upper surface of the barrel 130 faces a groove forming surface 111 which is a lower surface of the screw 110. A communication hole 132 that communicates with a flow path 142 of the discharge unit 140 is formed at the center of the barrel 130. A first heating unit 201 that heats a material supplied to grooves 113 of the screw 110 to be described later and a first detection unit 202 that detects a temperature of the grooves 113 of the screw 110 are accommodated in the barrel 130. Details of the barrel 130 will be described later.

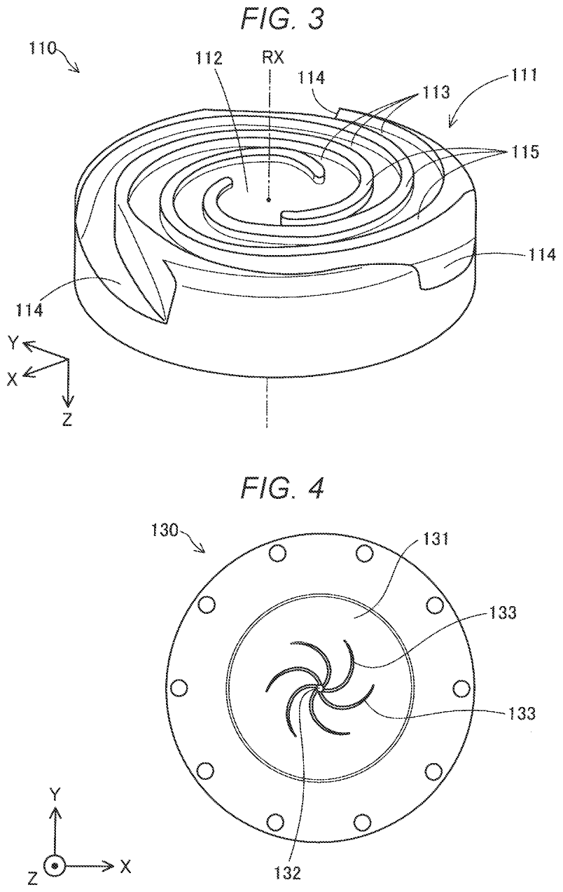

FIG. 3 is a perspective view illustrating a schematic configuration of the screw 110. The screw 110 has a substantially cylindrical shape in which a length in a direction along the rotation axis RX is smaller than a length in a direction perpendicular to the rotation axis RX. In the groove forming surface 111, the grooves 113 having a vortex shape are formed around a central portion 112. The grooves 113 communicate with a material inlet 114 formed in a side surface of the screw 110. A material supplied from the material supply unit 11 is supplied to the grooves 113 through the material inlet 114. The grooves 113 are formed by being separated by ridge portions 115. Although FIG. 3 illustrates an example in which three grooves 113 are formed, the number of grooves 113 may be one or two or more. A shape of the grooves 113 is not limited to a vortex shape, and may be a spiral shape or an involute curve shape, or may be a shape extending in an arc shape from the central portion 112 toward an outer periphery.

FIG. 4 is a schematic plan view illustrating the barrel 130. A plurality of guide grooves 133 are formed around the communication hole 132 in the facing surface 131. One end of the guide groove 133 is coupled to the communication hole 132, and extends in a vortex shape from the communication hole 132 toward an outer periphery of the facing surface 131. The one end of the guide groove 133 may be not coupled to the communication hole 132. The guide groove 133 may be not formed in the barrel 130.

The rotation of the screw 110 and heating by the first heating unit 201 causes the material supplied to the groove 113 of the screw 110 to flow along the groove 113 while being plasticized in the groove 113, and the material is guided to the central portion 112 of the screw 110 as a plasticized material. The paste-like plasticized material that exhibits fluidity and has flowed into the central portion 112 is supplied to the discharge unit 140 through the communication hole 132. In a plasticizing unit, not all types of substances constituting the plasticized material may be melted. The plasticized material may be converted into a state having fluidity as a whole by plasticizing at least some types of substances among the substances constituting the plasticized material.

The discharge unit 140 illustrated in FIG. 2 includes a block 141, the flow path 142, a flow rate adjusting unit 143, and a suction unit 144.

The block 141 is provided at a −Z direction side of the barrel 130. The flow path 142 is formed in the block 141. A second heating unit 203 that heats the block 141 and a second detection unit 204 that detects a temperature of the block 141 are accommodated in the block 141. Details of the block 141 will be described later.

The nozzle 13 is provided at a lower end of the block 141. The nozzle 13 is coupled to the communication hole 132 of the barrel 130 through the flow path 142. The nozzle 13 discharges the plasticized material generated in the plasticizing device 12 from a discharge port 145 at a tip end of the nozzle 13 toward the table 20.

The flow rate adjusting unit 143 rotates in the flow path 142 to change an opening degree of the flow path 142. The flow rate adjusting unit 143 is implemented by a butterfly valve. The flow rate adjusting unit 143 is controlled by the control unit 50. The control unit 50 controls a rotation angle of the butterfly valve, thereby adjusting a flow rate of the plasticized material flowing from the plasticizing device 12 to the nozzle 13, that is, a flow rate of the plasticized material discharged from the nozzle 13. The flow rate adjusting unit 143 adjusts a flow rate of the plasticized material and controls ON and OFF of an outflow of the plasticized material. The flow rate adjusting unit 143 may have a shutter mechanism, and the shutter mechanism may change an opening degree of the flow path 142 to adjust a flow rate of the plasticized material.

The suction unit 144 includes a cylinder that is coupled to the flow path 142 between the flow rate adjusting unit 143 and the discharge port 145, a plunger that reciprocates in the cylinder, and a plunger drive unit that drives the plunger. The suction unit 144 temporarily suctions the plasticized material in the flow path 142 into the cylinder when discharging of the plasticized material from the nozzle 13 is stopped, thereby preventing a tailing phenomenon in which the plasticized material drips from the discharge port 145 as if the plasticized material pulls a thread. The suction unit 144 is controlled by the control unit 50. In the embodiment, the flow rate adjusting unit 143 and the suction unit 144 are collectively referred to as a discharge adjusting unit.

When the control unit 50 stops discharging the plasticized material from the nozzle 13, the control unit 50 first controls the flow rate adjusting unit 143 to turn off an outflow of the plasticized material, and then controls the suction unit 144 to suction the plasticized material. When the control unit 50 restarts discharging the plasticized material from the nozzle 13, the control unit 50 controls the suction unit 144 to send out the plasticized material suctioned by the suction unit 144, and then controls the flow rate adjusting unit 143 to turn on an outflow of the plasticized material.

The table 20 is disposed at a position facing the discharge port 145 of the nozzle 13. The three-dimensional shaping device 100 shapes a three-dimensional shaped object by discharging a plasticized material from the nozzle 13 toward a shaping surface 21 of the table 20 to stack layers of a shaping layer.

The position changing unit 30 changes a relative position between the nozzle 13 and the table 20. In the embodiment, the position changing unit 30 changes a relative position between the nozzle 13 and the table 20 by moving the shaping unit 10 along the Z direction which is a stacking direction, and moving the table 20 in a direction intersecting the stacking direction. More specifically, the position changing unit 30 according to the embodiment changes a relative position between the nozzle 13 and the table 20 in the Z direction by moving the shaping unit 10 along the Z direction, and changes a relative position between the nozzle 13 and the table 20 in the X direction and the Y direction by moving the table 20 in the X direction and the Y direction. As illustrated in FIG. 1, the position changing unit 30 includes a first electric actuator 31 that moves the table 20 along the X direction, a second electric actuator 32 that moves the table 20 and the first electric actuator 31 along the Y direction, and a third electric actuator 33 that moves the shaping unit 10 along the Z direction. The third electric actuator 33 moves the first shaping unit 10a and the second shaping unit 10b along the Z direction by moving, along the Z direction, a movable portion 41 to which the first shaping unit 10a and the second shaping unit 10b are fixed. The third electric actuator 33 and the movable portion 41 are omitted in FIG. 2.

The first electric actuator 31, the second electric actuator 32, and the third electric actuator 33 described above are driven under the control of the control unit 50. For example, the position changing unit 30 may move the table 20 in the Z direction and move the shaping unit 10 along the X direction and the Y direction, may move the table 20 in the X direction, the Y direction, and the Z direction without moving the shaping unit 10, or may move the shaping unit 10 in the X direction, the Y direction, and the Z direction without moving the table 20.

The table heating unit 40 heats plasticized materials stacked on the table 20. The table heating unit 40 is fixed to the movable portion 41. The table heating unit 40 is moved in the Z direction by the third electric actuator 33 together with the shaping unit 10. As illustrated in FIG. 2, the table heating unit 40 is provided with an opening 42 penetrating in the Z direction. When a plasticized material is discharged to shape a three-dimensional shaped object, the nozzle 13 is located in the opening 42, and a tip end of the nozzle 13 is disposed between the table heating unit 40 and the table 20 in the Z direction.

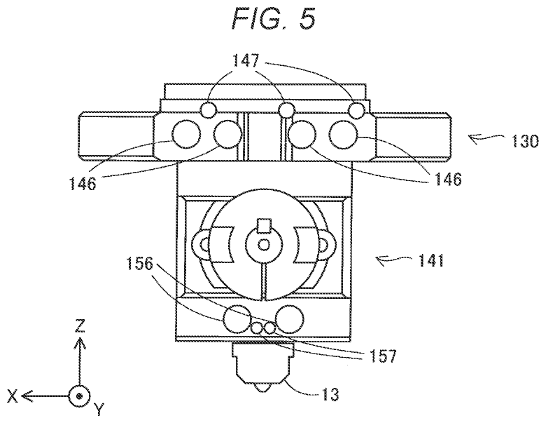

FIG. 5 is a side view illustrating the barrel 130 and the block 141. The barrel 130 is formed with first holes 146 for accommodating the first heating unit 201 and second holes 147 for accommodating the first detection unit 202. A direction in which the first hole 146 extends coincides with a direction in which the second hole 147 extends. That is, a direction in which the first heating unit 201 is inserted into the first holes 146 coincides with a direction in which the first detection unit 202 is inserted into the second holes 147. In the embodiment, a direction in which the first hole 146 extends and a direction in which the second hole 147 extends are the Y direction. In the present specification, the term “coincide” includes a state in which the directions are not completely coincide with each other and are slightly inclined relative to each other. For example, when a diameter of the first hole 146 is larger than a diameter of the first heating unit 201, or when a diameter of the second hole 147 is larger than a diameter of the first detection unit 202, a direction in which the first hole 146 extends and a direction in which the second hole 147 extends may be slightly inclined relative to each other.

The block 141 is formed with third holes 156 for accommodating the second heating unit 203 and fourth holes 157 for accommodating the second detection unit 204. A direction in which the third hole 156 extends coincides with a direction in which the fourth hole 157 extends. That is, a direction in which the second heating unit 203 is inserted into the third holes 156 coincides with a direction in which the second detection unit 204 is inserted into the fourth holes 157. In the embodiment, a direction in which the third hole 156 extends and a direction in which the fourth hole 157 extends are the Y direction. The direction in which the third hole 156 and the fourth hole 157 extend coincides with the direction in which the first hole 146 and the second hole 147 extend.

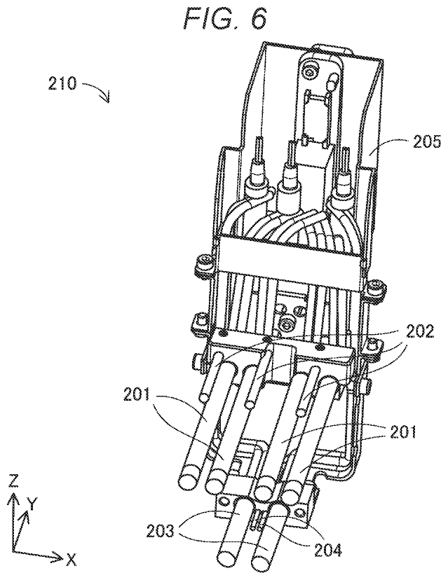

FIG. 6 is a perspective view illustrating a heater unit 210. The heater unit 210 includes the first heating unit 201, the first detection unit 202, the second heating unit 203, the second detection unit 204, and a fixing member 205. The first heating unit 201, the first detection unit 202, the second heating unit 203, and the second detection unit 204 have a cylindrical shape having an axis extending along the Y direction, and are provided in a manner of protruding from the fixing member 205 in the −Y direction. The first heating unit 201, the first detection unit 202, the second heating unit 203, and the second detection unit 204 are fixed to the fixing member 205, and are coupled by the fixing member 205. The fixing member 205 accommodates wirings of the first heating unit 201, the first detection unit 202, the second heating unit 203, and the second detection unit 204. The first heating unit 201 and the second heating unit 203 are, for example, a heater. The first detection unit 202 and the second detection unit 204 are, for example, a thermocouple. The first heating unit 201, the first detection unit 202, the second heating unit 203, and the second detection unit 204 are provided at positions where the first heating unit 201 is inserted into the first holes 146, the first detection unit 202 is inserted into the second holes 147, the second heating unit 203 is inserted into the third holes 156, and the second detection unit 204 is inserted into the fourth holes 157 when the heater unit 210 is coupled to the plasticizing device 12.

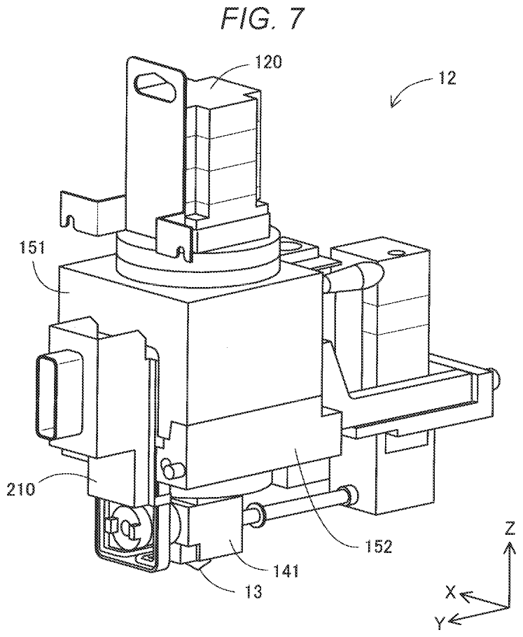

FIG. 7 is a view illustrating a state in which the heater unit 210 is coupled to the plasticizing device 12. When the heater unit 210 is coupled to the plasticizing device 12, the first heating unit 201 is inserted into the first holes 146, the first detection unit 202 is inserted into the second holes 147, the second heating unit 203 is inserted into the third holes 156, and the second detection unit 204 is inserted into the fourth holes 157. That is, when the heater unit 210 is coupled to the plasticizing device 12, the first heating unit 201 and the first detection unit 202 are disposed in the barrel 130, and the second heating unit 203 and the second detection unit 204 are disposed in the block 141.

According to the three-dimensional shaping device 100 of the embodiment described above, the first holes 146 and the second holes 147 are formed in the barrel 130, the third holes 156 and the fourth holes 157 are formed in the block 141, and directions of the first holes 146, the second holes 147, the third holes 156, and the fourth holes 157 coincide with one another. In addition, the heater unit 210 includes the first heating unit 201, the first detection unit 202, the second heating unit 203, and the second detection unit 204, and the first heating unit 201, the first detection unit 202, the second heating unit 203, and the second detection unit 204 are coupled by the fixing member 205. Therefore, when the heater unit 210 is coupled to the plasticizing device 12, the first heating unit 201 is inserted into the first holes 146, the first detection unit 202 is inserted into the second holes 147, the second heating unit 203 is inserted into the third holes 156, and the second detection unit 204 is inserted into the fourth holes 157. When the heater unit 210 is coupled to the plasticizing device 12 from one direction, the first detection unit 202 can be inserted into the second holes 147 at the same time with the insertion of the first heating unit 201 into the first holes 146. Further, when the heater unit 210 is coupled to the plasticizing device 12 from one direction, the second heating unit 203 and the second detection unit 204 can be coupled to the block 141 at the same time with the coupling of the first heating unit 201 and the first detection unit 202 to the barrel 130. Therefore, the first heating unit 201, the first detection unit 202, the second heating unit 203, and the second detection unit 204 can be collectively coupled to the plasticizing device 12 by coupling the heater unit 210 to the plasticizing device 12, and the first heating unit 201, the first detection unit 202, the second heating unit 203, and the second detection unit 204 can be collectively detached from the plasticizing device 12 by detaching the heater unit 210 from the plasticizing device 12. Therefore, maintenance work of the plasticizing device 12 can be facilitated.

In the embodiment, a direction in which the first holes 146 extend coincides with a direction in which the second holes 147 extend, and the first heating unit 201 and the first detection unit 202 can be collectively inserted into the barrel 130 by coupling the heater unit 210 to the plasticizing device 12, so that it is possible to prevent positions of the first heating unit 201 and the first detection unit 202 in the barrel 130 from varying depending on the individual barrel 130 as compared with a case where the first heating unit 201 and the first detection unit 202 are inserted into the barrel 130 from different directions. Further, a direction in which the third holes 156 extend coincides with a direction in which the fourth holes 157 extend, and the second heating unit 203 and the second detection unit 204 can be collectively inserted into the block 141 by coupling the heater unit 210 to the plasticizing device 12, so that it is possible to prevent positions of the second heating unit 203 and the second detection unit 204 in the block 141 from varying depending on the individual block 141 as compared with a case where the second heating unit 203 and the second detection unit 204 are inserted into the block 141 from different directions. Since wirings of the first heating unit 201, the first detection unit 202, the second heating unit 203, and the second detection unit 204 are accommodated in the fixing member 205, when the heater unit 210 is coupled to the plasticizing device 12, it is possible to prevent the wirings from being stuck between the heater unit 210 and the plasticizing device 12.

### B. Second Embodiment

In the second embodiment, the block 141 has first through holes 161 and a second through hole 171. Configuration of components of the three-dimensional shaping device 100 other than the block 141 are similar to those in the first embodiment.

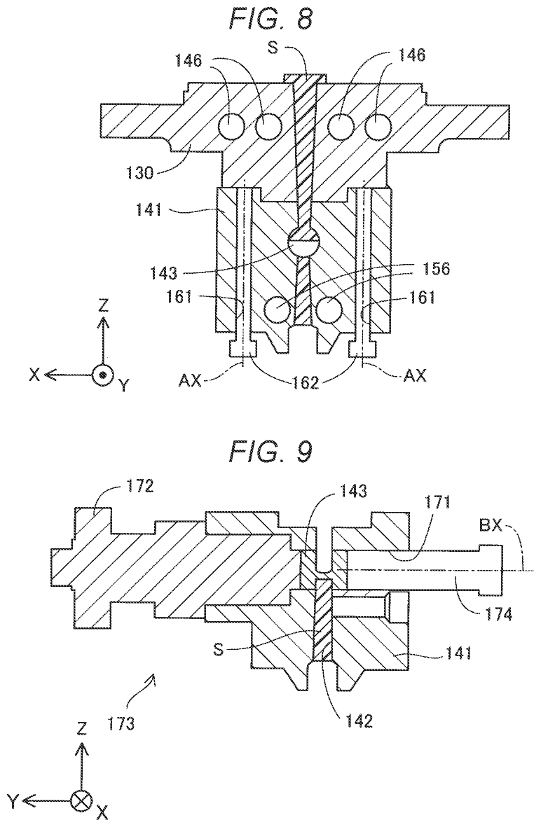

FIG. 8 is a cross-sectional view taken along a plane perpendicular to the Y direction and illustrating the barrel 130 and the block 141 according to the second embodiment. The first through holes 161 extend in a direction away from the barrel 130 from a surface of the block 141 facing the barrel 130. In the embodiment, the first through holes 161 are formed in a manner of penetrating the block 141 in the Z direction. A screw groove is formed inside the first through hole 161.

The barrel 130 and the block 141 are coupled by being engaged with each other. In the embodiment, the block 141 is fixed to the barrel 130 by a screw (not illustrated).

As illustrated in FIG. 8, a solid matter S obtained by solidifying the plasticized material used when a three-dimensional shaped object is shaped adheres to the barrel 130 and the block 141 of the three-dimensional shaping device 100 after the three-dimensional shaped object is shaped. Therefore, even when a screw that engages the barrel 130 and the block 141 is removed, the barrel 130 and the block 141 may not be separated from each other since the barrel 130 and the block 141 are bonded to each other by the solid matter S. In this case, the barrel 130 and the block 141 are separated using push bolts 162. Specifically, the push bolts 162 are inserted into the first through holes 161, the push bolts 162 are rotated about a rotation axis AX, and the push bolts 162 are moved in the +Z direction. When tip ends of the push bolts 162 push a lower surface of the barrel 130, a space between the lower surface of the barrel 130 and an upper surface of the block 141 increases, and the block 141 is moved in the −Z direction.

FIG. 9 is a cross-sectional view taken along a plane perpendicular to the X direction and illustrating the block 141 according to the second embodiment. The second through hole 171 is formed from a side surface in the −Y direction of the block 141 toward the flow rate adjusting unit 143. A direction in which the second through hole 171 extends is the Y direction. A screw groove is formed inside the second through hole 171.

A transmission unit 172 for transmitting power of a motor that drives the flow rate adjusting unit 143 to the flow rate adjusting unit 143 is coupled to the block 141. The transmission unit 172 is coupled to the block 141 from a +Y direction side of the flow rate adjusting unit 143. That is, the transmission unit 172 is coupled to the block 141 from a side opposite to the second through hole 171 across the flow rate adjusting unit 143. The flow rate adjusting unit 143 and the transmission unit 172 are collectively referred to as a valve unit 173. The valve unit 173 can be separated from the block 141.

As illustrated in FIG. 9, the solid matter S adheres to the flow path 142 of the block 141 and the flow rate adjusting unit 143 after a three-dimensional shaped object is shaped. Therefore, the valve unit 173 and the block 141 may not be separated from each other since the valve unit 173 and the block 141 are bonded to each other by the solid matter S. In this case, the valve unit 173 and the block 141 are separated using a push bolt 174. Specifically, the push bolt 174 is inserted into the second through hole 171, the push bolt 174 is rotated about a rotation axis BX, and the push bolt 174 is moved in the +Y direction. When a tip end of the push bolt 174 pushes the flow rate adjusting unit 143, the valve unit 173 is moved in the +Y direction. When the three-dimensional shaping device 100 shapes a three-dimensional shaped object, the second through hole 171 may be closed by a cap member or the like instead of the push bolt 174.

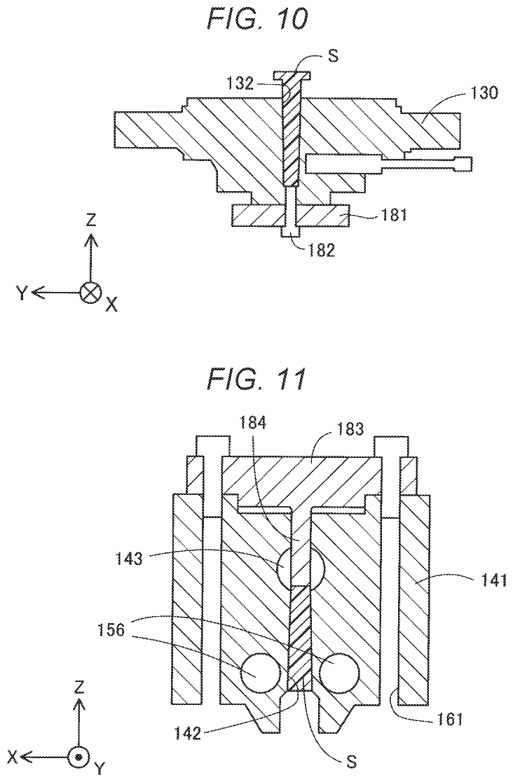

FIG. 10 is a view illustrating an example of a method of removing the solid matter S adhering to the communication hole 132 of the barrel 130. When removing the solid matter S remaining in the communication hole 132 of the barrel 130, a fixture 181 is fixed to a lower surface of the barrel 130, a screw 182 is inserted into the communication hole 132 through a screw hole formed in the fixture 181, and the screw 182 is moved in the +Z direction to push out the solid matter S in the communication hole 132 in the +Z direction.

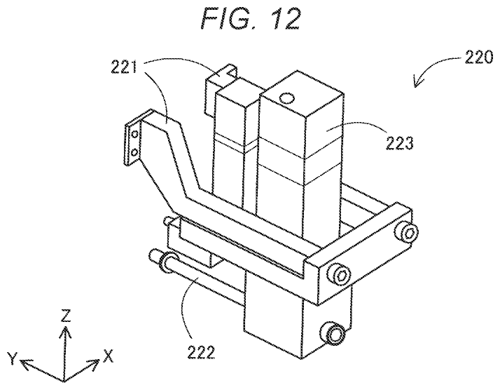

FIG. 11 is a view illustrating an example of a method of removing the solid matter S adhering to the flow path 142 of the block 141. When removing the solid matter S remaining at a downstream of the flow rate adjusting unit 143 in the flow path 142 of the block 141, a protruding portion 184 of a fixture 183 is inserted into the flow path 142 from the +Z direction, and the fixture 183 is moved in the −Z direction to push out the solid matter S in the flow path 142 in the −Z direction.

According to the three-dimensional shaping device 100 of the embodiment described above, the block 141 has the first through holes 161, and the push bolts 162 are inserted into the first through holes 161 and push a lower surface of the barrel 130, so that the barrel 130 and the block 141 can be separated even when the solid matter S adheres to the barrel 130 and the block 141 after a three-dimensional shaped object is shaped. Therefore, the barrel 130 and the block 141 can be separated without heating and softening the solid matter S remaining in the barrel 130 and the block 141. Accordingly, maintenance work of the barrel 130 and the block 141 can be facilitated.

In addition, the block 141 has the second through hole 171, and the push bolt 174 is inserted into the second through hole 171 and pushes the valve unit 173, so that the valve unit 173 and the block 141 can be separated even when the solid matter S adheres to the flow path 142 of the block 141 and the flow rate adjusting unit 143 after a three-dimensional shaped object is shaped. Therefore, the valve unit 173 and the block 141 can be separated without heating and softening the solid matter S remaining in the flow path 142 of the block 141 and the flow rate adjusting unit 143. Accordingly, maintenance work of the valve unit 173 and the block 141 can be facilitated.

### C. Third Embodiment

In the third embodiment, the three-dimensional shaping device 100 includes a placement portion 230 on which a discharge adjusting unit separated from the three-dimensional shaping device 100 can be placed, and a support portion 211 by which the plasticizing device 12 is suspended. In the third embodiment, the plasticizing device 12 can be separated into a first portion 191 and a second portion 192. Configurations of components of the three-dimensional shaping device 100 other than the plasticizing device 12, the placement portion 230, and the support portion 211 are similar to those in the first embodiment.

FIG. 12 is a perspective view illustrating a plunger unit 220. The plunger unit 220 includes first engagement portions 221, a plunger 222, and a plunger drive unit 223. The plunger 222 and the plunger drive unit 223 are respectively similar to the plunger and the plunger drive unit of the suction unit 144 described in the first embodiment. The first engagement portions 221 are members provided in a manner of protruding from the plunger unit 220 in the +Y direction. The plunger 222 is driven by the plunger drive unit 223 implemented by a motor. In the third embodiment, the plunger unit 220 can be separated from the three-dimensional shaping device 100.

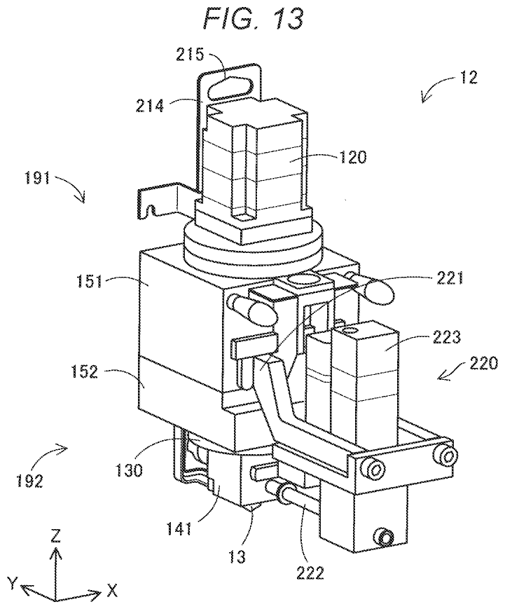

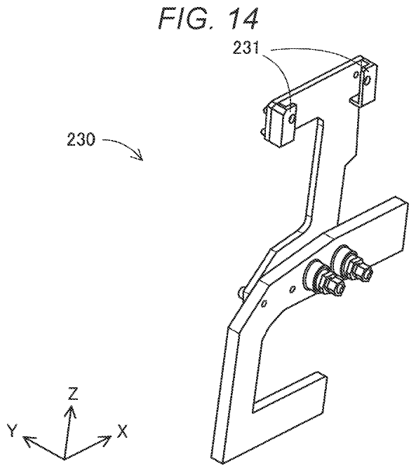

FIG. 13 is a view illustrating a state in which the plunger unit 220 is coupled to the plasticizing device 12. The plunger unit 220 is fixed to the plasticizing device 12 by fixing end portions of the first engagement portions 221 to a side surface of the upper case 151. When the plunger unit 220 is coupled to the plasticizing device 12, the plunger 222 is inserted into a cylinder that is provided in the block 141 and coupled to the flow path 142.

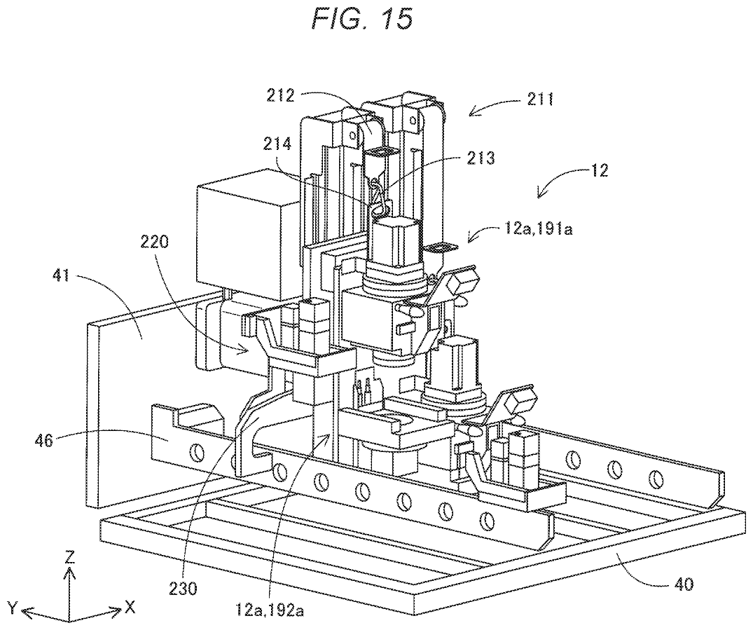

FIG. 14 is a perspective view illustrating the placement portion 230. The plunger unit 220 separated from the plasticizing device 12 is placed on the placement portion 230. The placement portion 230 includes two plates coupled by bolts. The placement portion 230 has second engagement portions 231. The second engagement portions 231 are provided at an upper end of the placement portion 230. End portions of the first engagement portions 221 of the plunger unit 220 are hooked on the second engagement portions 231, so that the first engagement portions 221 and the second engagement portions 231 are engaged with each other. The plunger unit 220 is placed on the placement portion 230 by engaging the first engagement portions 221 and the second engagement portions 231. The second engagement portions 231 may be formed with screw holes for fixing end portions of the first engaging portions 221 with screws, and the first engagement portions 221 and the second engagement portions 231 may be engaged with each other with screws.

FIG. 15 is a perspective view illustrating the three-dimensional shaping device 100 according to the third embodiment. As illustrated in FIG. 15, a lower end of the placement portion 230 is fixed to an arm portion 46 fixed to the movable portion 41 of the three-dimensional shaping device 100. FIG. 15 illustrates a state in which the plunger unit 220 is placed on the placement portion 230.

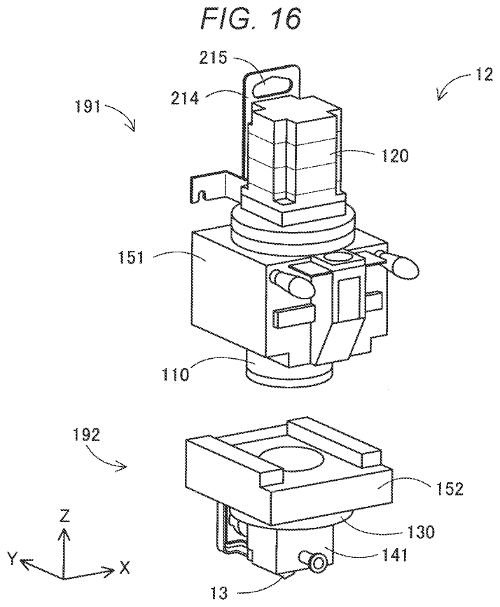

FIG. 16 is a perspective view illustrating the plasticizing device 12 in a state in which the first portion 191 and the second portion 192 are separated. The first portion 191 includes the drive motor 120, the drive shaft 121, the upper case 151, and the screw 110. The second portion 192 includes the lower case 152, the barrel 130, and the block 141. Before the plasticizing device 12 is separated into the first portion 191 and the second portion 192, the plunger unit 220 is detached from the plasticizing device 12.

As illustrated in FIG. 15, the support portion 211 is provided at a +Y direction side and a +Z direction side of the plasticizing device 12, and is fixed to the movable portion 41. The first portion 191 of the plasticizing device 12 is suspended by the support portion 211. FIG. 15 shows a state in which a first portion 191a of the first plasticizing device 12a is suspended by the support portion 211. The support portion 211 includes a spring 212 and a second coupling portion 213. The spring 212 is, for example, a plate spring. The spring 212 is preferably a constant force spring. The second coupling portion 213 is a member that is fixed to a lower end of the spring 212 and from which the first portion 191 is suspended. The second coupling portion 213 is, for example, a hook.

The first portion 191 includes a first coupling portion 214. As illustrated in FIGS. 13 and 16, the first coupling portion 214 is provided at an upper end of the plasticizing device 12. The first coupling portion 214 is a plate-shaped member having an opening 215, and is fixed to the drive motor 120. The second coupling portion 213 is caught in the opening 215 of the first coupling portion 214, so that the first portion 191 is suspended by the support portion 211. The second portion 192 is not suspended by the support portion 211.

According to the three-dimensional shaping device 100 in the embodiment described above, the plunger unit 220 can be separated from the three-dimensional shaping device 100, and the plunger unit 220 detached from the three-dimensional shaping device 100 can be placed on the placement portion 230 by engaging the first engagement portions 221 of the plunger unit 220 with the second engagement portions 231 of the placement portion 230. Therefore, compared to a case where the placement portion 230 is not provided, when the plunger unit 220 is detached from the three-dimensional shaping device 100, it is not necessary to place the plunger unit 220 at an unstable place, and the plunger unit 220 can be placed in a more stable state. Accordingly, maintenance work of the three-dimensional shaping device 100 can be performed more safely.

In the embodiment, since the plasticizing device 12 can be separated into the first portion 191 and the second portion 192, and the first portion 191 is suspended by the support portion 211, when the plasticizing device 12 is separated into the first portion 191 and the second portion 192, it is possible to detach only the second portion 192 from the three-dimensional shaping device 100 while leaving the first portion 191 in the three-dimensional shaping device 100. Since the plasticizing device 12 is a heavy object, when only the second portion 192 is detached from the three-dimensional shaping device 100, it is possible to reduce a weight of a component to be detached from the three-dimensional shaping device 100 as compared with a case where the whole plasticizing device 12 is detached from the three-dimensional shaping device 100. Accordingly, maintenance work of the plasticizing device 12 can be facilitated. In addition, when the plasticizing device 12 is separated into the first portion 191 and the second portion 192, since the screw 110 and the barrel 130 are separated from each other, maintenance work of the screw 110 and the barrel 130 can be facilitated.

In the embodiment, the plasticizing device 12 may include the valve unit 173 described in the second embodiment. The valve unit 173 may have a first engagement portion, and the valve unit 173 may be placed on the placement portion by engaging the first engagement portion of the valve unit 173 with a second engagement portion of a placement portion different from the placement portion 230. In the embodiment, the plunger unit 220 and the valve unit 173 are collectively referred to as a discharge adjusting unit. The discharge adjusting unit adjusts a discharge amount of a plasticized material from the nozzle 13 and can be separated from the three-dimensional shaping device 100.

### D. Fourth Embodiment

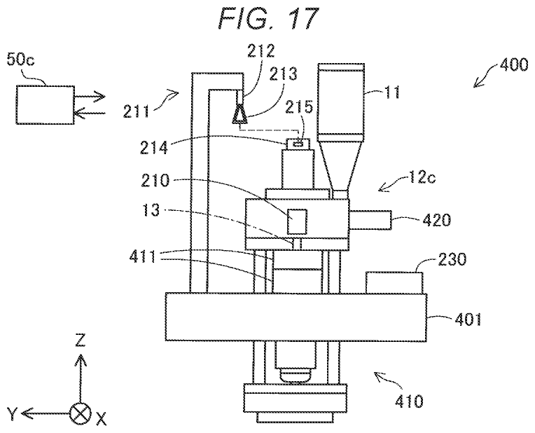

FIG. 17 is an explanatory view illustrating a schematic configuration of an injection molding device 400 according to the fourth embodiment. The injection molding device 400 includes the material supply unit 11, a plasticizing device 12c, the nozzle 13, a mold clamping device 410, a control unit 50c, the heater unit 210, the support portion 211, and the placement portion 230. In the embodiment, elements denoted by the same reference numerals as those in the first embodiment are the same as those in the first embodiment.

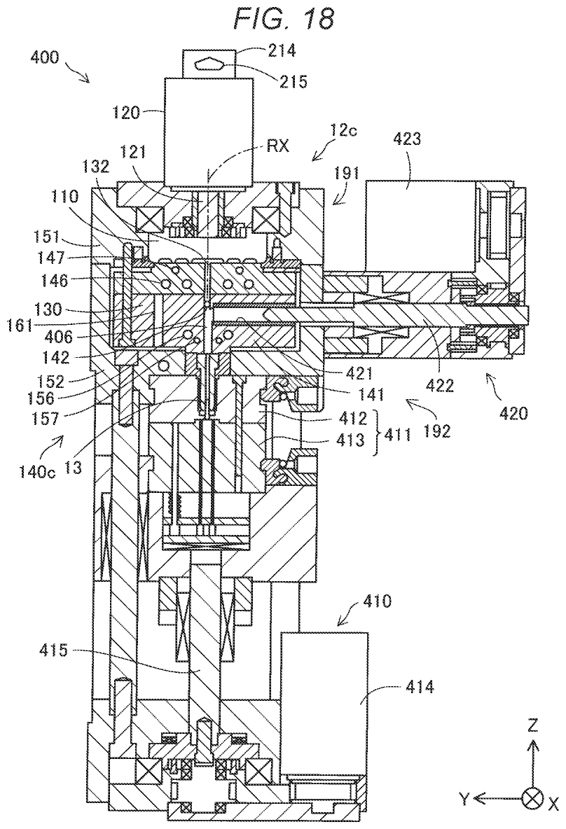

FIG. 18 is a cross-sectional view illustrating a schematic configuration of the plasticizing device 12c and the mold clamping device 410 according to the fourth embodiment. The plasticizing device 12c includes the screw 110, the drive motor 120, the barrel 130, a discharge unit 140c, and the first coupling portion 214.

In the embodiment, the discharge unit 140c includes the block 141, the flow path 142, a check valve 406, and a suction and sending unit 420. The check valve 406 is provided in the flow path 142 of the block 141, and prevents a backflow of a plasticized material from the nozzle 13 to the screw 110. The suction and sending unit 420 includes a suction and sending cylinder 421, a plunger 422, and a plunger drive unit 423. The suction and sending unit 420 has a function of injecting a plasticized material in the suction and sending cylinder 421 into a molding mold 411. The plunger 422 moves in the suction and sending cylinder 421 in a direction away from the flow path 142 to suction a plasticized material into the suction and sending cylinder 421 and measure the plasticized material. Thereafter, the plunger 422 moves in the suction and sending cylinder 421 in a direction approaching the flow path 142 to send the plasticized material to the flow path 142. The plasticized material sent to the flow path 142 is pressure-fed to the nozzle 13 and is injected from the nozzle 13 into the molding mold 411. The plunger 422 is driven by the plunger drive unit 423. The plunger 422 and the plunger drive unit 423 can be separated from the injection molding device 400. In the embodiment, the plunger 422 and the plunger drive unit 423 are also referred to as a discharge adjusting unit.

Similar to the first embodiment, the first holes 146 and the second holes 147 are formed in the barrel 130. Similar to the first embodiment, the third holes 156 and the fourth holes 157 are formed in the block 141. When the heater unit 210 is coupled to the plasticizing device 12c as illustrated in FIG. 17, the first heating unit 201 is inserted into the first holes 146, the first detection unit 202 is inserted into the second holes 147, the second heating unit 203 is inserted into the third holes 156, and the second detection unit 204 is inserted into the fourth holes 157.

Similar to the third embodiment, the plasticizing device 12c may be separated into the first portion 191 and the second portion 192. Similar to the third embodiment, the first coupling portion 214 is provided at an upper end of the plasticizing device 12c. Similar to the second embodiment, the block 141 is formed with the first through holes 161 extending from a surface facing the barrel 130 in a direction away from the barrel 130. Other configurations of the plasticizing device 12c are the same as those of the plasticizing device 12 in the first embodiment.

The molding mold 411 includes a fixed mold 412 and a movable mold 413. The fixed mold 412 is fixed to the plasticizing device 12c. The movable mold 413 can be moved forward and backward in a mold clamping direction relative to the fixed mold 412 by the mold clamping device 410. The plasticized material generated by the plasticizing device 12c is injected from the nozzle 13 into a cavity defined by the fixed mold 412 and the movable mold 413. The molding mold 411 may be made of metal, resin, or ceramic. The metal molding mold 411 is also referred to as a mold.

The mold clamping device 410 includes a mold drive unit 414. The mold drive unit 414 includes a motor, a gear, and the like, and is coupled to the movable mold 413 via a ball screw 415. The mold clamping device 410 drives the mold drive unit 414 under the control of the control unit 50c to rotate the ball screw 415 and move the movable mold 413 relative to the fixed mold 412 to open and close the molding mold 411.

As illustrated in FIG. 17, the placement portion 230 is fixed on a base 401 of the injection molding device 400. A discharge adjusting unit separated from the injection molding device 400 is placed on the placement portion 230.

The support portion 211 is fixed on the base 401 of the injection molding device 400. Similar to the third embodiment, the second coupling portion 213 fixed to a lower end of the spring 212 is caught in the opening 215 of the first coupling portion 214 of the plasticizing device 12c, so that the first portion 191 of the plasticizing device 12c is suspended by the support portion 211.

According to the injection molding device 400 in the fourth embodiment described above, the first holes 146 and the second holes 147 are formed in the barrel 130, and the third holes 156 and the fourth holes 157 are formed in the block 141 in a similar manner to the first embodiment. Therefore, the first heating unit 201, the first detection unit 202, the second heating unit 203, and the second detection unit 204 can be collectively coupled to the plasticizing device 12c by coupling the heater unit 210 to the plasticizing device 12c, and the first heating unit 201, the first detection unit 202, the second heating unit 203, and the second detection unit 204 can be collectively detached from the plasticizing device 12c by detaching the heater unit 210 from the shaping unit 10, so that maintenance work of the plasticizing device 12c can be facilitated.

Further, in the embodiment, since the block 141 has the first through holes 161, similar to the second embodiment, the barrel 130 and the block 141 can be separated from each other by inserting the push bolts 162 into the first through holes 161 and pushing a lower surface of the barrel 130 without heating and softening a solid matter S that remains in the barrel 130 and the block 141 and is obtained by solidifying the plasticized material. Accordingly, maintenance work of the barrel 130 and the block 141 can be facilitated.

In the embodiment, since the injection molding device 400 includes the placement portion 230, a discharge adjusting unit separated from the injection molding device 400 can be placed on the placement portion 230. Therefore, when the discharge adjusting unit is detached from the injection molding device 400, it is not necessary to place the discharge adjusting unit at an unstable place, and the discharge adjusting unit can be placed in a more stable state.

In the embodiment, the plasticizing device 12c can be separated into the first portion 191 and the second portion 192, and the first portion 191 is suspended by the support portion 211, so that when the plasticizing device 12c is separated into the first portion 191 and the second portion 192, it is possible to detach only the second portion 192 from the injection molding device 400 while leaving the first portion 191 in the injection molding device 400. Since the plasticizing device 12c is a heavy object, when only the second portion 192 is detached from the injection molding device 400, it is possible to reduce a weight of a component to be detached from the injection molding device 400 as compared with a case where the whole plasticizing device 12c is detached from the injection molding device 400.

### E. Other Embodiments

(E-1) In the first embodiment and the fourth embodiment, the heater unit 210 includes the second heating unit 203 and the second detection unit 204. On the other hand, the heater unit 210 may not include the second heating unit 203 and the second detection unit 204. When the heater unit 210 does not include the second heating unit 203 and the second detection unit 204, a direction in which the third holes 156 and the fourth holes 157 extend may not coincide a direction in which the first holes 146 and the second holes 147 extend. That is, a direction in which the second heating unit 203 is inserted into the third holes 156 and a direction in which the second detection unit 204 is inserted into the fourth holes 157 may not coincide with a direction in which the first heating unit 201 is inserted into the first holes 146 and a direction in which the first detection unit 202 is inserted into the second holes 147.

(E-2) In the third embodiment and the fourth embodiment, the plasticizing device 12 can be separated into the first portion 191 and the second portion 192. On the other hand, the plasticizing device 12 may not be separated into the first portion 191 and the second portion 192.

(E-3) In the third embodiment and the fourth embodiment, the first portion 191 is suspended by the support portion 211. On the other hand, instead of the first portion 191, the entire plasticizing device 12 may be suspended by the support portion 211.

(E-4) In the third embodiment and the fourth embodiment, the first portion 191 includes the screw 110, and the second portion 192 includes the barrel 130. On the other hand, the first portion 191 may not include the screw 110. That is, the plasticizing device 12 may be separated in a manner in which the second portion 192 includes the screw 110. The second portion 192 may not include the barrel 130. That is, the plasticizing device 12 may be separated in a manner in which the first portion 191 includes the barrel 130.

(E-5) In the third embodiment and the fourth embodiment, the second coupling portion 213 is caught in the opening 215 of the first coupling portion 214, so that the first portion 191 is suspended by the support portion 211. On the other hand, the second coupling portion 213 may have an opening, and the first coupling portion 214 may be caught in the opening of the second coupling portion 213, so that the first portion 191 is suspended by the support portion 211. In addition, the first coupling portion 214 and the second coupling portion 213 may be caught by each other, so that the first portion 191 is suspended by the support portion 211.

(E-6) In the fourth embodiment, the block 141 may not include the first through holes 161. The injection molding device 400 may not include the support portion 211 or the placement portion 230.

### F. Other Aspects

The present disclosure is not limited to the embodiments described above, and can be implemented in various aspects without departing from the spirit of the present disclosure. For example, the present disclosure can be implemented in the following aspects. In order to solve a part of or all problems of the present disclosure, or to achieve a part of or all effects of the present disclosure, technical features of the above-described embodiments corresponding to technical features in the following aspects can be replaced or combined as appropriate. Technical features can be deleted as appropriate unless described as essential in the present specification.

(1) According to a first aspect of the present disclosure, a plasticizing device that plasticizes a material to generate a plasticized material is provided. The plasticizing device includes: a screw having a groove forming surface on which a groove is formed, a barrel having a facing surface that faces the groove forming surface and formed with a communication hole through which the plasticized material flows outside, a first heating unit disposed in the barrel and configured to heat the material supplied to the groove, and a first detection unit disposed in the barrel and configured to detect a temperature of the groove, in which the barrel is formed with a first hole for accommodating the first heating unit and a second hole for accommodating the first detection unit, a direction in which the first hole extends coincides with a direction in which the second hole extends, and the first heating unit and the first detection unit are coupled to each other via a fixing member. According to this aspect, since the first heating unit and the first detection unit can be collectively coupled to the barrel and can be collectively detached from the barrel from one direction, maintenance work of the plasticizing device can be facilitated.

(2) In the first aspect, the plasticizing device may further include a block in which a flow path communicating with the communication hole is formed, and a second heating unit disposed in the block and configured to heat the block, in which the block may be formed with a third hole for accommodating the second heating unit, a direction in which the third hole extends may coincide with the direction in which the first hole and the second hole extend, and the second heating unit may be fixed to the fixing member. According to this aspect, the second heating unit can be coupled to the block at the same time when the first heating unit and the first detection unit are coupled to the barrel, and the second heating unit can be detached from the block at the same time when the first heating unit and the first detection unit are detached from the barrel, so that maintenance work of the plasticizing device can be facilitated.

(3) In the first aspect, the plasticizing device may further include a block in which a flow path communicating with the communication hole is formed, in which the barrel and the block may be coupled by being engaged with each other, and the block may have a first through hole extending from a surface facing the barrel in a direction away from the barrel. According to this aspect, even when a solid matter obtained by solidifying the plasticized material adheres to the barrel and the block, the barrel and the block can be easily separated by inserting a push bolt into the first through hole and pushing the barrel with the push bolt, so that maintenance work of the plasticizing device can be facilitated.

(4) According to a second aspect of the present disclosure, a three-dimensional shaping device is provided. The three-dimensional shaping device includes the plasticizing device and a nozzle configured to discharge the plasticized material toward a table.

(5) In the second aspect, the plasticizing device may include a first coupling portion, and the three-dimensional shaping device may further include a support portion that includes a second coupling portion, the plasticizing device is suspended by the support portion by coupling the first coupling portion and the second coupling portion. According to this aspect, since the plasticizing device is suspended by the support portion, it is possible to move the plasticizing device that is a heavy object from an original position without detaching the plasticizing device from the three-dimensional shaping device, and it is possible to perform maintenance for the three-dimensional shaping device.

(6) In the second aspect, the plasticizing device may be separable into a first portion and a second portion, and the first portion may include the first coupling portion. According to this aspect, the first portion is suspended from the support portion by coupling the first coupling portion and the second coupling portion, and it is possible to reduce a weight of a component to be detached from the three-dimensional shaping device by detaching only the second portion from the three-dimensional shaping device while leaving the first portion in the three-dimensional shaping device.

(7) In the second aspect, the first portion may include the screw, and the second portion may include the barrel. According to this aspect, maintenance work of the screw and the barrel can be facilitated.

(8) In the second aspect, the three-dimensional shaping device may further include a discharge adjusting unit including a first engagement portion, configured to adjust a discharge amount of the plasticized material from the nozzle, and separable from the three-dimensional shaping device; and a placement portion including a second engagement portion and on which the discharge adjusting unit is placed, the discharge adjusting unit being separated by engaging the first engagement portion and the second engagement portion. According to this aspect, when maintenance of the three-dimensional shaping device is performed, the discharge adjusting unit can be placed at a stable place in the three-dimensional shaping device.

(9) According to a third aspect of the present disclosure, an injection molding device is provided. The injection molding device includes the plasticizing device and a nozzle configured to inject the plasticized material into a molding mold.

What is claimed is:

1. A plasticizing device that plasticizes a material to generate a plasticized material, the plasticizing device comprising:
a screw having a groove forming surface on which a groove is formed;
a barrel having a facing surface that faces the groove forming surface and formed with a communication hole through which the plasticized material flows outside;
a first heating unit disposed in the barrel and configured to heat the material supplied to the groove; and
a first detection unit disposed in the barrel and configured to detect a temperature of the groove, wherein
the barrel is formed with a first hole for accommodating the first heating unit and a second hole for accommodating the first detection unit,
a direction in which the first hole extends coincides with a direction in which the second hole extends, and
the first heating unit and the first detection unit are coupled to each other via a fixing member.

2. The plasticizing device according to claim 1, further comprising:
a block in which a flow path communicating with the communication hole is formed; and
a second heating unit disposed in the block and configured to heat the block, wherein
the block is formed with a third hole for accommodating the second heating unit,
a direction in which the third hole extends coincides with the direction in which the first hole and the second hole extend, and
the second heating unit is fixed to the fixing member.

3. The plasticizing device according to claim 1, further comprising:
a block in which a flow path communicating with the communication hole is formed, wherein
the barrel and the block are coupled by being engaged with each other, and
the block has a first through hole extending from a surface facing the barrel in a direction away from the barrel.

4. A three-dimensional shaping device comprising:
the plasticizing device according to claim 1; and
a nozzle configured to discharge the plasticized material toward a table.

5. The three-dimensional shaping device according to claim 4, wherein
the plasticizing device includes a first coupling portion, and
the three-dimensional shaping device further comprises a support portion that includes a second coupling portion, the plasticizing device being suspended by the support portion by coupling the first coupling portion and the second coupling portion.

6. The three-dimensional shaping device according to claim 5, wherein
the plasticizing device is separable into a first portion and a second portion, and
the first portion includes the first coupling portion.

7. The three-dimensional shaping device according to claim 6, wherein
the first portion includes the screw, and the second portion includes the barrel.

8. The three-dimensional shaping device according to claim 4, further comprising:
a discharge adjusting unit including a first engagement portion, configured to adjust a discharge amount of the plasticized material from the nozzle, and separable from the three-dimensional shaping device; and
a placement portion including a second engagement portion and on which the discharge adjusting unit is placed, the discharge adjusting unit being separated by engaging the first engagement portion and the second engagement portion.
